(19) United States
(12) Patent Application Publication
(10) Pub. No.: US 2026/0170772 A1
(43) Pub. Date: Jun. 18, 2026

(54) SYSTEMS AND METHODS FOR SPATIALLY-ANCHORED VOLUMETRIC TELEPRESENCE AND CLINICAL IMAGE VISUALIZATION

(71) Applicant: The Regents of the University of California, Oakland, CA (US)

(72) Inventors: Nadir Weibel, La Jolla, CA (US); Brett Meyer, San Diego, CA (US); Weichen Liu, San Diego, CA (US)

(21) Appl. No.: 19/400,797

(22) Filed: Nov. 25, 2025

Related U.S. Application Data
(60) Provisional application No. 63/725,191, filed on Nov. 26, 2024.

(51) Int. Cl. G06T 19/00; G06F 3/01; G06T 5/70; G06T 9/00; G06T 13/20; G06T 13/40; G06T 15/08; G06T 17/20

(52) U.S. Cl. CPC G06T 19/006; G06F 3/012; G06T 5/70; G06T 9/00; G06T 13/205; G06T 13/40; G06T 15/08; G06T 17/20; G06F 3/013; G06F 3/017; G06T 2207/10024; G06T 2207/10028; G06T 2207/10081; G06T 2207/20182; G06T 2207/30196; G06T 2210/08; G06T 2210/41; G06T 2210/56; G06T 2219/024

(57) ABSTRACT

Embodiments described herein relate to systems and methods for volumetric telepresence in which a participant is captured, reconstructed, and rendered as a real-time holographic image spatially anchored within a remote environment. A plurality of depth-sensing cameras positioned around a capture zone acquire synchronized depth and color data of the participant, which a processing subsystem reconstructs into a volumetric representation, encodes, and transmits to a remote spatial display device. The spatial display device decodes and renders the holographic image while maintaining spatial registration between the local and remote coordinate systems. In some embodiments, a headset worn by the participant includes inward-facing sensors configured to capture facial-expression data while the participant's face is partially occluded. The system animates a personalized facial model according to the captured expression data and merges the animated model with the live volumetric reconstruction to produce a composite representation for lifelike, bidirectional holographic communication.

### CROSS REFERENCE TO RELATED APPLICATIONS

This patent application claims priority to, and thus the benefit of an earlier effective filing date from, U.S. Provisional Patent Application No. 63/725,191 (filed Nov. 26, 2024), the contents of which are hereby incorporated by reference. This patent application is also related to commonly owned and co-pending U.S. patent application Ser. No. 19/347,276 (filed Oct. 1, 2025), the contents of which are hereby incorporated by reference.

### FIELD

The present invention relates generally to systems and methods for real-time holographic communication, and more particularly to systems for capturing, transmitting, and rendering volumetric representations of persons for spatially anchored telepresence within augmented reality (AR), virtual reality (VR), or mixed reality (MR) environments.

### BACKGROUND

Three-dimensional (3D) display technologies have advanced significantly in recent years, allowing users to perceive and interact with digital content in spatial environments. Virtual reality (VR), augmented reality (AR), and mixed reality (MR) systems have been developed for immersive visualization and collaboration. Conventional VR collaboration platforms typically represent participants as computer-generated avatars reconstructed from skeletal tracking or pose estimation data. While these systems enable virtual meetings, they do not present accurate volumetric reproductions of the participants in real time, nor do they allow those reproductions to coexist naturally within a user's physical environment.

Separately, holographic projection systems used for entertainment or demonstration purposes, such as stage “holograms,” generate visual illusions of 3D figures by projecting two-dimensional (2D) video or computer-generated imagery onto a reflective surface. These approaches rely on optical effects such as Pepper's Ghost and do not capture or transmit volumetric data. The resulting images lack depth parallax, true spatial coherence, and interactivity. Consequently, such displays are unsuitable for real-time telepresence or for applications requiring spatial precision or environmental anchoring.

Recent developments in volumetric capture have enabled multi-camera systems to reconstruct 3D representations of individuals by combining synchronized depth and color data from multiple sensors. However, existing volumetric capture implementations are confined to controlled studio environments and are optimized for content production rather than live transmission. Real-time streaming of volumetric data poses challenges in data bandwidth, latency, spatial calibration, and compression, and existing systems generally fail to support low-latency, spatially anchored rendering suitable for interactive use.

Traditional video-based teleconferencing systems remain limited to two-dimensional perspectives presented on flat displays. Participants cannot perceive true spatial relationships, natural eye contact, or the relative scale and orientation of other participants. These limitations reduce the sense of presence and hinder realistic collaboration, particularly in settings where spatial context is significant.

Accordingly, there remains a need for a system capable of capturing a live volumetric representation of a person, transmitting that data in real time, and rendering the representation as a spatially anchored hologram viewable through an AR or MR headset. Such a system would allow remote participants to appear at life scale within each other's environments, enabling natural communication through voice, gesture, and spatial interaction. In professional applications such as remote consultation, education, and clinical communication, this capability would provide the realism and immediacy of in-person interaction while maintaining the advantages of remote accessibility.

### SUMMARY

Systems and methods are disclosed for providing real-time volumetric telepresence by capturing a live three-dimensional (3D) representation of a person, transmitting the captured data to a remote location, and rendering the person as a spatially anchored hologram within an augmented reality (AR) or mixed reality (MR) environment. The disclosed system enables users located in different physical environments to communicate as if co-located, perceiving one another at true scale and in correct spatial alignment, while interacting naturally through speech, gesture, and motion.

The system generally includes a plurality of depth-sensing cameras positioned around a capture zone to obtain synchronized depth and color data of a person. A processing subsystem receives and fuses the data from the cameras to reconstruct a volumetric representation, such as a point cloud or mesh, in real time. The processing subsystem may further compress and encode the volumetric data stream for network transmission. At a remote endpoint, an AR or MR display device receives the transmitted data, decodes the volumetric stream, and renders the holographic representation of the person spatially anchored within the local environment of the viewer.

The system may perform automatic calibration of the capture and rendering environments to maintain geometric consistency between the physical and virtual coordinate spaces. Positional anchors, fiducial markers, or depth registration algorithms may be employed to align the holographic representation with environmental features in the viewing location. In certain implementations, the system enables bidirectional holographic communication, in which each participant is captured, transmitted, and rendered as a volumetric hologram visible to the other.

The disclosed system may further integrate auxiliary digital content, including two-dimensional (2D) or three-dimensional (3D) objects, images, or medical imaging data, within the same spatial environment. A participant may manipulate or reference such content using gesture or voice commands while maintaining visual contact with the remote participant's holographic representation. This configuration enables shared spatial interaction and collaborative review of digital material.

By enabling real-time volumetric telepresence, the disclosed systems provide a perceptually realistic communication experience that conveys spatial context, depth, and nonverbal cues absent from conventional video conferencing. The systems may be applied to remote professional collaboration, education, design, clinical consultation, or other scenarios where spatial realism and presence improve understanding and engagement.

In one embodiment, a system is provided for volumetric telepresence. The system includes a plurality of depth-sensing cameras positioned around a capture zone and configured to acquire synchronized depth and color data of a participant in real time. A processing subsystem is configured to reconstruct a volumetric representation of the participant from the synchronized depth and color data, to encode the volumetric representation as a data stream, and to transmit the encoded stream over a network to a remote spatial display device. The spatial display device is configured to decode the volumetric representation, render the decoded data as a hologram of the participant that appears spatially anchored within a local physical environment, and maintain spatial registration between the coordinate system of the local environment and that of the capture zone so that the holographic image appears at a corresponding position and orientation in both spaces. The system further updates the spatial registration dynamically as the participant moves and maintains real-time synchronization of the volumetric representation to support natural conversational interaction.

In certain implementations, the spatial registration between the local and remote coordinate systems is established and maintained using fiducial-marker detection, simultaneous localization and mapping (SLAM), or other sensor-fusion techniques that combine inertial and optical tracking data. The processing subsystem may compress the reconstructed volumetric representation using a point-cloud codec optimized for low-latency transmission, typically maintaining end-to-end latency below about one hundred milliseconds. The spatial display device may be embodied as a virtual-reality head-mounted display capable of rendering the hologram of the participant with six-degree-of-freedom parallax corresponding to the viewer's movements, thereby preserving natural depth perception and perspective.

In further embodiments, the spatial display device detects hand gestures and eye-gaze direction of the viewer and interprets these inputs as interaction commands for manipulating shared spatial content within the local environment. The system may operate in a bidirectional mode in which volumetric representations of both participants are simultaneously captured, transmitted, and rendered in real time, enabling lifelike two-way holographic communication. The system may also spatially co-locate digital or virtual objects within both the capture zone and the local physical environment so that participants can collaboratively view and manipulate shared three-dimensional content as if occupying the same space.

During operation, the system can dynamically adjust calibration parameters of both the depth-sensing cameras and the spatial display device to compensate for environmental drift, lighting variation, or physical movement, thereby preserving geometric correspondence between the capture and viewing environments. The processing subsystem may further apply temporal smoothing or motion-prediction filtering to the synchronized depth and color data to reduce frame-to-frame jitter in the rendered hologram while maintaining real-time responsiveness. Additionally, the spatial display device may adjust the lighting, shading, or color balance of the rendered hologram in response to ambient-light measurements within the local environment to enhance visual integration of the holographic image with surrounding real-world elements.

In another embodiment, a method is provided for volumetric telepresence. The method includes acquiring, with a plurality of depth-sensing cameras positioned around a capture zone, synchronized depth and color data of a participant in real time. The method further includes reconstructing, by a processing subsystem, a volumetric representation of the participant from the synchronized depth and color data. The reconstructed volumetric representation is then encoded and transmitted as a data stream over a network to a remote spatial display device, which receives, decodes, and renders a hologram of the participant that appears spatially anchored within the local physical environment of the device. During operation, the method maintains spatial registration between the coordinate system of the local environment and that of the capture zone so that the holographic image appears at a corresponding position and orientation in both spaces. The registration is dynamically updated during motion of the participant, and the volumetric representation is maintained in real-time synchronization to permit natural conversational interaction between participants.

In some implementations, maintaining spatial registration involves calibrating the coordinate systems using fiducial markers, simultaneous localization and mapping (SLAM), or other sensor-fusion techniques that combine inertial and optical tracking data. The method may also include compressing the volumetric representation using a point-cloud codec optimized for low-latency transmission, enabling near-real-time operation with an overall delay below approximately one hundred milliseconds. The holographic rendering may be performed within a virtual-reality head-mounted display or other spatial display device that provides six-degree-of-freedom parallax responsive to viewer movement, thereby preserving natural spatial perception and depth cues.

Additional embodiments include detecting hand gestures and eye-gaze direction of the viewer and interpreting those inputs as commands for manipulating shared spatial content within the environment. The method may be implemented bidirectionally such that a volumetric representation of each participant is simultaneously captured, transmitted, and rendered at the remote endpoint, establishing a two-way holographic communication channel. In some examples, the method further includes spatially co-locating digital objects within both the capture zone and the local physical environment so that participants at both sites can view, point to, or manipulate the same three-dimensional data, models, or imagery as if occupying the same shared space.

The method may also dynamically adjust calibration parameters of the depth-sensing cameras and the spatial display device to compensate for environmental drift, lighting variation, or physical movement, while preserving geometric correspondence between the two environments. Temporal smoothing or motion-prediction filtering may be applied to the synchronized depth and color data to reduce jitter between frames, producing a stable yet responsive holographic display. In addition, the rendering engine of the spatial display device may adapt lighting, shading, and color balance of the hologram in response to ambient-light measurements taken within the viewer's environment to improve the visual realism and integration of the holographic representation with nearby real-world surfaces and objects.

Through these combined steps, the disclosed method provides a real-time, spatially anchored, and perceptually natural form of holographic communication in which participants can see and interact with each other's life-scale, volumetric representations as though co-located in the same room. The resulting experience conveys depth, presence, and nonverbal cues not achievable with conventional two-dimensional video conferencing systems, thereby enhancing clarity, engagement, and realism in remote collaboration and communication.

In a further embodiment, a system is provided for headset-aware volumetric telepresence. The system includes one or more depth-sensing cameras positioned around a capture zone and configured to acquire synchronized depth and color data of a participant in real time. A processing subsystem reconstructs a volumetric representation of the participant from the synchronized data. The participant wears a headset that includes one or more inward-facing sensors arranged to capture facial-expression information while the participant's face is partially occluded by the visor of the headset. The processing subsystem is further configured to perform a pre-conference enrollment procedure in which a personalized three-dimensional facial model of the participant is generated from multi-view depth and color imagery of the participant's uncovered face. During live operation, the subsystem receives real-time facial-expression data from the headset, animates the personalized facial model in accordance with that data, and merges the animated model with the concurrently reconstructed volumetric body to produce a composite volumetric representation containing a reconstructed face region. The composite representation is then encoded and transmitted to a remote spatial display device for real-time rendering as a holographic image that includes the participant's facial features and expressions.

In some implementations, the personalized facial model comprises a parametric face mesh incorporating user-specific texture, normal, and albedo maps derived from the enrollment imagery, thereby capturing individual skin tone, fine-scale geometry, and lighting response. The headset may include multiple inward-facing cameras, a chin-mounted or downward-looking camera, and one or more microphone arrays. The processing subsystem combines visual signals from these cameras with inertial data from the headset and audio-derived viseme information from the microphones to compute a set of facial-expression parameters that accurately reproduce the participant's speech-related and emotional movements.

In certain embodiments, the volumetric body data and the facial animation data are transmitted as two coordinated streams. A first stream may carry a video-based point-cloud compression (V-PCC) representation of the body geometry and texture, while a second lightweight stream conveys blendshape coefficients and head-pose metadata describing the animated facial motion. At the remote site, the spatial display device reconstructs the participant's face locally by applying the received blendshape coefficients to a stored facial template corresponding to that participant. This hybrid architecture minimizes bandwidth requirements while preserving photorealistic facial animation and low latency.

To ensure visual continuity, the processing subsystem may perform color and illumination matching between the reconstructed facial model and the surrounding live-captured geometry. Techniques such as Poisson-domain blending or depth-aware feathering are applied to eliminate seams and harmonize shading so that the inserted facial region blends naturally with the adjacent neck and head surfaces. For security and privacy, the personalized facial model and the associated expression data are encrypted end-to-end, and the facial template is maintained locally so that only the animation coefficients traverse the network.

In still other embodiments, a learned neural network is applied to predict unobserved facial motion in regions hidden by the headset, using partial visual cues, inertial signals, and stored enrollment imagery to infer complete facial dynamics. The system may also align spatialized audio output with the reconstructed mouth position of the animated facial model, ensuring that speech emanates from the correct location within the holographic image and that audiovisual cues remain perceptually consistent. Together, these elements produce a realistic and expressive telepresence experience in which participants appear with unobstructed, dynamically animated faces even while wearing head-mounted displays, thereby restoring natural eye contact and conversational nuance in fully immersive holographic communication.

Other illustrative embodiments (e.g., methods and computer-readable media relating to the foregoing embodiments) may be described below. The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a schematic diagram illustrating an exemplary system for volumetric telepresence including a plurality of depth-sensing cameras arranged around a capture zone, a processing subsystem configured to reconstruct and transmit a volumetric representation of a participant, and a remote spatial display device for rendering a holographic image of the participant.

FIG. 2 is a flow diagram illustrating an exemplary method for capturing, reconstructing, encoding, transmitting, decoding, and rendering a volumetric representation of a participant to enable real-time holographic communication between remote locations.

FIG. 3 is a block diagram illustrating an exemplary hardware and software architecture of a spatial display device or mixed-reality headset configured to perform volumetric decoding, tracking, and rendering operations for holographic telepresence.

FIG. 4 is a perspective view of an exemplary mixed-reality headset configured to render holographic imagery in an optical see-through configuration using holographic waveguides or optical combiners.

FIG. 5 is a perspective view of an exemplary virtual-reality headset configured for immersive volumetric visualization of holographic participants or three-dimensional content.

FIG. 6 is a block diagram illustrating an exemplary computing environment operable to execute the volumetric capture, reconstruction, encoding, transmission, and rendering processes described herein, and including local and cloud-based computing resources.

FIG. 7 is a schematic diagram illustrating an exemplary headset-aware volumetric telepresence system configured to capture inward-facing facial-expression data from a participant wearing a head-mounted display, to animate a personalized facial model based on the captured data, to merge the animated model with externally acquired volumetric imagery of the participant, and to transmit a composite volumetric representation for real-time holographic rendering.

FIG. 8 illustrates another exemplary embodiment of a system for volumetric telepresence that incorporates additional augmented-reality objects and clinical visualizations.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

The embodiments of the instant disclosure may include or be implemented in conjunction with various types of artificial reality systems. Artificial reality is a form of reality that has been adjusted in some manner before presentation to a user, which may include, e.g., a virtual reality (VR), an augmented reality (AR), a mixed reality (MR), or some combination thereof. Artificial reality content may include completely generated content or generated content combined with captured (e.g., real-world) content. The artificial reality content may include video, audio, haptic feedback, or some combination thereof, any of which may be presented in a single channel or in multiple channels, such as stereo video that produces a three-dimensional effect to the viewer. As used herein, extended reality (XR) is a term that is intended to encompass all forms of artificial reality.

Artificial reality systems may be implemented in a variety of different form factors and configurations. Some artificial reality systems may be designed to work with a head-mounted display (HMD). In artificial reality, an HMD device may partially or completely obstruct the user's view of the real-world environment. Depending on the devices, the user may see all or a portion of the user's surroundings. Thus, as part of a training phase, in some embodiments, the user may first be prompted to visualize the real-world environment with the HMD device, which can generate a model of that environment. During an interaction or operational phase, the user may interact with a virtual environment, such that the movement of a user from one location to another in the virtual environment is accomplished by the user moving within the real-world environment. For example, the user may move objects within the virtual environment being presented in a display of the HMD device the user is wearing. To provide the user with awareness of the real-world environment during the interaction phase, a portion of the model generated during the training phase may be shown to the user in a display along with the virtual scene or environment.

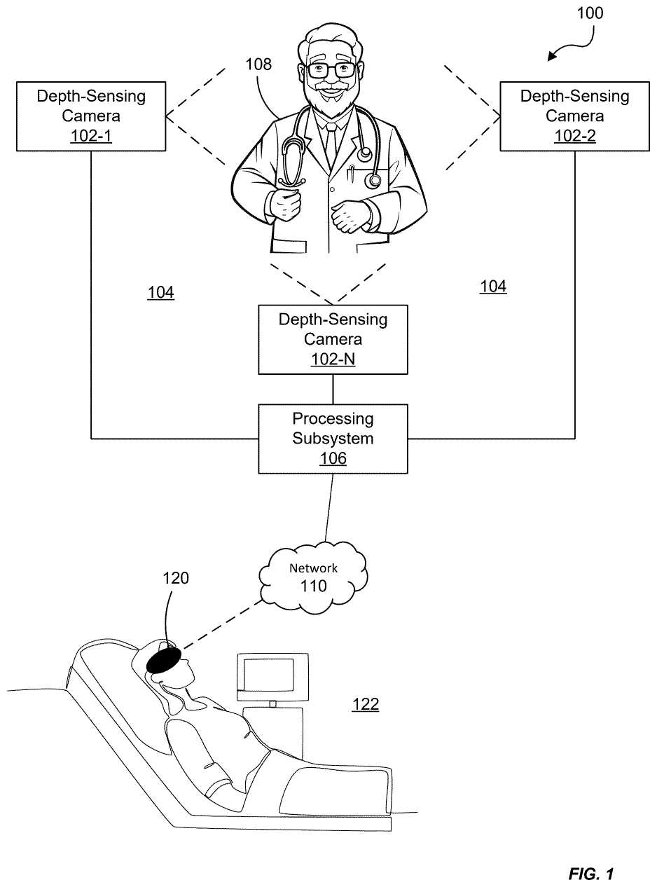

FIG. 1 illustrates an exemplary operating environment 100 for implementing volumetric telepresence between a capture location and a remote visualization endpoint. A plurality of depth-sensing cameras 102-1 through 102-N are disposed around a capture zone 104 in which a participant 108 is positioned. Each depth-sensing camera may include at least one imaging sensor and one or more emitters configured to project structured-light, infrared, or time-of-flight (ToF) signals. The return signal from each emitter is analyzed to determine the distance between the camera and discrete surface points of the participant, producing per-pixel depth data synchronized with color (RGB) data from an image sensor. Exemplary camera modules may include Microsoft Azure Kinect, Intel RealSense D435, or custom stereoscopic rigs employing CMOS sensors with global-shutter optics. In alternative embodiments, the cameras may comprise lidar scanners, photogrammetry arrays, or plenoptic sensors capable of capturing light-field data.

The cameras 102 are positioned to provide overlapping fields of view encompassing the participant 108 from multiple angles. Each camera 102 may be rigidly mounted relative to a capture rig or calibrated frame such that its intrinsic and extrinsic parameters—focal length, lens distortion coefficients, and three-dimensional position and orientation—are known. A calibration routine may employ a fiducial target or a checkerboard pattern to compute a unified coordinate system for the capture zone 104. During operation, each camera 102 generates synchronized depth frames and color frames that are time-stamped and transmitted to a processing subsystem 106. The cameras may communicate via a high-bandwidth interface such as USB 3.0, Ethernet, or a dedicated optical link, ensuring minimal latency and frame loss. The capture rate may range from 30 to 120 frames per second depending on available throughput.

The processing subsystem 106 receives the multi-view depth and color data and performs real-time volumetric reconstruction of the participant. Reconstruction begins with per-camera depth-map filtering to remove invalid pixels and temporal noise using bilateral or Kalman filtering. The filtered depth maps are then transformed into a common world coordinate frame using the previously determined extrinsic calibration matrices. In one embodiment, the subsystem fuses all depth maps into a volumetric occupancy grid using a truncated signed-distance function (TSDF) or voxel-hashing algorithm, producing a continuous 3D field representing the participant's surface geometry. In another embodiment, the system performs multi-view stereo (MVS) triangulation or point-cloud merging using iterative closest-point (ICP) registration to align surfaces. Color information from each camera is mapped onto the reconstructed mesh using texture-projection and blending techniques that compensate for occlusions and varying illumination. The result is a dynamically updating volumetric representation of the participant suitable for real-time streaming.

Once reconstructed, the volumetric representation is encoded into a compressed data stream by the processing subsystem 106. Compression may employ octree quantization, predictive geometry coding, or specialized point-cloud codecs such as MPEG V-PCC (Video-based Point Cloud Compression) or G-PCC (Geometry-based PCC). The subsystem may also apply temporal inter-frame prediction to exploit redundancy between consecutive frames, reducing bandwidth requirements while maintaining motion fidelity. The encoded stream is transmitted over a network 110—which may include Ethernet, Wi-Fi 6, 5G, or fiber links—to a spatial display device 120 located at a remote environment 122. End-to-end system latency may be maintained below approximately 100 milliseconds to support conversational responsiveness.

The spatial display device 120 receives and decodes the transmitted volumetric stream to render a spatially anchored hologram of the participant within the local physical environment 122. In one embodiment, the spatial display device is an augmented-reality (AR) headset configured to overlay the holographic representation onto the user's view of the physical world. In another embodiment, the device is a virtual-reality (VR) headset that renders the participant within a fully synthetic environment. The display device determines the viewer's head pose and position relative to the environment using simultaneous localization and mapping (SLAM) and inertial-measurement-unit (IMU) data. The system aligns the hologram's coordinate frame with that of the environment to achieve spatial registration—ensuring the hologram remains fixed in space as the viewer moves. This may be accomplished by mapping visual features of the environment (e.g., walls, furniture, or fiducial markers) and computing a transformation matrix between the remote capture-zone coordinate frame and the local frame. The rendering engine continuously updates this matrix to correct for drift, maintaining sub-centimeter positional accuracy. As a result, the holographic participant appears life-sized, properly scaled, and co-located with shared digital content or physical references in the room.

In some embodiments, the spatial display device 120 further tracks the viewer's hand gestures and eye gaze using embedded cameras or infrared sensors. Gesture inputs may be interpreted as commands to reposition, scale, or highlight elements within the holographic scene—for instance, to draw attention to a region of interest or manipulate shared 3D content. Audio capture and reproduction may be synchronized with the volumetric stream, providing spatialized sound emanating from the apparent location of the holographic participant.

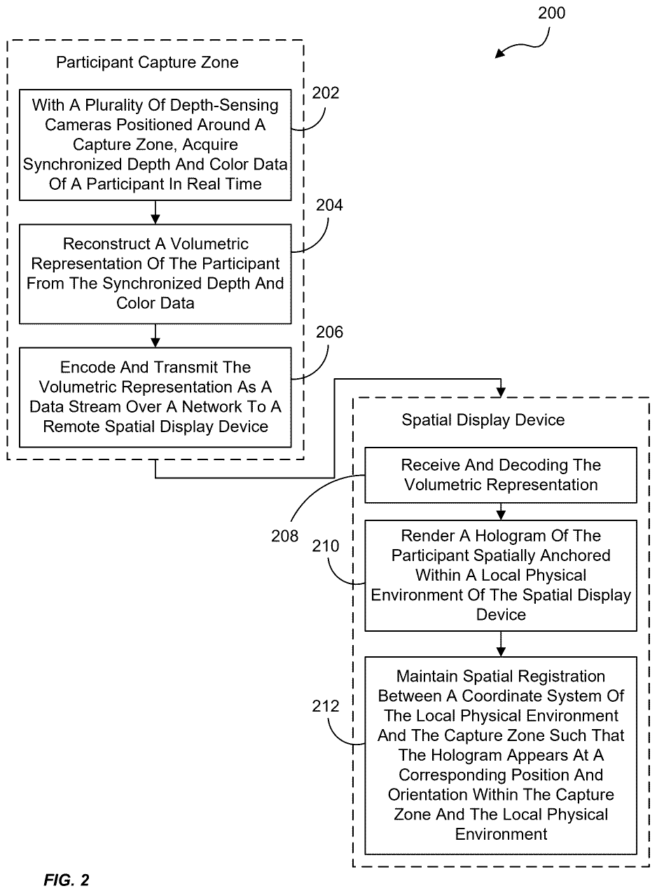

FIG. 2 illustrates an exemplary method 200 for acquiring, processing, transmitting, and rendering a real-time volumetric representation of a participant, according to various embodiments of the disclosure. The method 200 is representative of the logical flow executed by one or more computing or processing subsystems in cooperation with a plurality of depth-sensing cameras positioned around a defined capture zone. The sequence of operations shown in the figure may be performed in the order indicated or, in some embodiments, concurrently or in alternate order depending upon system architecture, network bandwidth, or latency constraints.

In step 202, the system acquires synchronized depth and color data of a participant in real time using a plurality of depth-sensing cameras arranged around a capture zone. Each camera, such as the cameras 102-1 through 102-N shown in FIG. 1, generates a color image and an associated depth map for each frame. The depth component may be produced by structured-light projection, time-of-flight ranging, or stereo correlation between two or more optical sensors within each camera module. The cameras may be rigidly mounted so that their extrinsic parameters—position, orientation, and baseline separation—are fixed relative to the capture coordinate system. To maintain synchronization among the multiple viewpoints, the cameras may share a hardware trigger or a global clock signal distributed through a synchronization hub. Each camera therefore produces a depth frame and an RGB frame that are temporally aligned and time-stamped, allowing each pixel's distance value to be correlated with its color information. In a representative configuration, each camera operates at a frame rate between 30 and 90 frames per second, capturing depth data with millimeter-scale precision. The plurality of camera streams collectively define a dense multi-view dataset encompassing the participant from nearly all angles, minimizing occlusions and enabling faithful 3-D reconstruction.

In step 204, the system reconstructs a volumetric representation of the participant from the synchronized depth and color data. Each pixel in each depth map is first converted into a three-dimensional point having X, Y, and Z coordinates relative to the capture coordinate frame. The corresponding RGB value from the color image is then assigned to that point, forming a colored point cloud. The point clouds from the various cameras are merged through geometric calibration that accounts for the cameras'extrinsic matrices and lens-distortion coefficients. The merged data may be filtered temporally and spatially to remove outliers, fill small gaps, and reduce surface noise caused by sensor uncertainty. A volumetric fusion algorithm such as a truncated signed-distance function (TSDF), a voxel-hashing scheme, or a neural radiance-field reconstruction may be applied to integrate the depth observations into a coherent surface representation. The resulting volumetric model captures the participant's true geometry and texture in three-dimensional space, updating dynamically at video frame rates. In some embodiments, photometric correction, ambient-light compensation, or adaptive smoothing is applied to produce a stable and visually continuous mesh suitable for real-time rendering.

In step 206, the volumetric representation is encoded and transmitted as a data stream to a remote site. Because the raw volumetric data can exceed several gigabits per second, the system employs an efficient compression scheme to achieve practical transmission bandwidths. A video-based point-cloud compression (V-PCC) process may be used, in which the three-dimensional geometry and texture data are projected into two-dimensional patch atlases that can be encoded using existing video codecs such as HEVC (H.265) or AV1. The encoding process segments the 3-D surface into patches of similar orientation, flattens each patch into a two-dimensional geometry map, and encodes both geometry and texture using motion-compensated inter-frame prediction, transform coding, and entropy compression. The encoded geometry and texture bitstreams may be multiplexed into a container format and transmitted over a network 110, which may include wired Ethernet, optical fiber, Wi-Fi 6E, or 5G wireless connections. The system may adaptively adjust bitrate or frame resolution in response to network conditions, maintaining a target end-to-end latency below approximately 100 milliseconds to preserve conversational timing. In medical or enterprise applications, each transmitted frame may be encrypted using an AES-128 or AES-256 cipher to protect patient data or confidential information.

In step 208, the encoded volumetric data is received and decoded by a remote spatial display device 120. The decoding subsystem reverses the compression process, reconstructing the geometry and texture atlases and re-projecting the encoded patches back into three-dimensional space. The decoded point cloud or mesh is regenerated with sub-centimeter spatial fidelity and updated continuously as new frames arrive. In some implementations, the decoding operation is performed by a local compute pack or edge processor associated with the headset, which sends the rendered images to the head-mounted display through a low-latency streaming protocol. In other embodiments, all decoding and rendering are performed on-device within the headset itself.

Step 210 maintains spatial registration between the coordinate system of the local physical environment and that of the remote capture zone. The spatial display device uses simultaneous localization and mapping (SLAM) algorithms to identify persistent anchor points such as walls, tables, or fiducial markers, establishing a transformation matrix that maps the coordinate frame of the holographic scene to that of the local environment. The device continuously updates this matrix based on input from inertial and optical sensors so that the holographic representation remains fixed in position even as the viewer moves. This ensures that the hologram appears to occupy a consistent real-world location relative to the viewer's surroundings.

In step 212, the spatial display device renders a hologram of the participant spatially anchored within the user's physical environment. A rendering engine of the processing subsystem 106 composites the decoded volumetric model with a live video or optical see-through view of the real world. Dynamic lighting estimation may be used to match the hologram's illumination to the ambient conditions of the room, and occlusion blending ensures that real objects in front of the hologram correctly obscure portions of the virtual figure. The final output presents the holographic participant at life scale with correct perspective, depth, and motion parallax. As the viewer walks around, the hologram exhibits natural perspective shifts corresponding to the viewer's head motion, reinforcing the perception of co-presence. Through these coordinated stages of acquisition, reconstruction, encoding, decoding, registration, and rendering, the method 200 achieves real-time volumetric telepresence in which remote participants appear as spatially stable holograms that can interact naturally within the viewer's physical surroundings.

Alternative embodiments of method 200 may include feedback and interactivity enhancements. For example, bidirectional implementation allows both parties to act as capture and display endpoints simultaneously, enabling conversational telepresence. Additional metadata such as gaze direction, hand pose, or physiological signals may be embedded within the encoded stream to enhance realism and interaction. The same method may be applied beyond telemedicine to remote training, education, engineering design, and collaborative simulation, demonstrating the scalability of the volumetric transmission architecture across diverse domains.

In an alternative embodiment, the core volumetric pipeline of method 200 is retained—multi-camera depth and color acquisition (step 202), volumetric reconstruction (step 204), low-latency encoding and transmission (step 206), decoding (step 208), registration (step 210), and hologram rendering (step 212)—but the system adds a headset-aware facial restoration subsystem that replaces the portion of the live point-cloud occluded by a visor with a photorealistic, expression-matched 3D face model. As a first phase, a short pre-conference enrollment is performed without a headset, using the same depth-sensing array to capture high-resolution multi-view color and depth of the participant's head and neck. The system solves a personalized facial template by fitting a parametric face mesh to the captured geometry, then bakes subject-specific texture (albedo), fine-scale normal maps, and hair proxies into that mesh. A radiometric calibration sequence maps camera color space to the display pipeline so that skin tones remain consistent across sites despite lighting differences. The resulting subject profile—consisting of calibrated textures, a neutral mesh, and a set of expression “blendshape” bases—is stored locally for that user.

During the live session, each participant wears a mixed-reality or virtual-reality headset. The outward-facing depth cameras still provide full-body geometry, but the upper face is partially occluded by the visor. To recover real-time facial motion, the headset gathers expression signals from several sources that are not blocked: inward-facing eye cameras yield brow movement and lid aperture; a small downward-looking “chin bar” camera mounted on or just below the visor captures the mouth region; miniature cheek sensors or an additional short-baseline stereo pair at the lower rim capture nasolabial motion; and the microphone stream provides phoneme/viseme timing, allowing the mouth interior to be animated even when not fully seen. These signals are generally fused to estimate a time-varying vector of blendshape weights for the user's enrolled face. Simultaneously, the live outward point-cloud is reconstructed as usual for the visible body, headset, and clothing. The system then carves a “facial hole” in the live point-cloud at the occluded region and inserts the enrolled face mesh, animated by the current blendshape weights, at the correct pose relative to the skull. Seamless compositing is achieved by depth-aware feathering at the face-helmet boundary and Poisson-domain color blending so that skin tone transitions match the neck and ears still coming from the live point-cloud. A lightweight photometric model estimates incident illumination from the headset's world cameras, and that lighting is re-applied to the facial normals so the restored face matches the room lighting of the local site.

For transport efficiency the compositor can send either the fully fused 3D stream or, more efficiently, transmit (i) the standard video-based point-cloud compression (V-PCC) stream for the non-face body geometry and (ii) a very small facial animation side-channel carrying only blendshape coefficients and head pose. At the receiver, the decoder reconstructs the body from the V-PCC atlases and reconstitutes the remote participant's face by driving the stored facial template for that user with the side-channel coefficients before compositing the two. This hybrid approach preserves photorealistic facial detail while keeping end-to-end latency within conversational bounds and leverages the same low-latency streaming architecture already described for holographic telepresence. Advantages of the V-PCC portion mirror those already discussed-reuse of mature video hardware blocks, inter-frame prediction, and large bit rate reductions-while the facial side-channel avoids repeatedly transmitting high-detail facial geometry when only expressions change.

Several implementation variations address different headset designs and clinical settings. In one version, the visor includes a short, transparent window or a thin outward camera module aligned to the mouth so that the system directly observes lips and teeth, improving viseme accuracy for speech-intensive encounters. In another, when outward facial cameras are not permitted (for comfort or infection-control reasons), the system falls back to audio-driven viseme synthesis for the mouth interior combined with inward eye-camera cues for upper-face motion; because the user-specific facial template was built in enrollment, even this reduced-sensor mode remains plausibly photoreal. In high-security settings the enrolled facial assets never leave the local node: each site keeps its own user's facial template, the remote site receives only the animation coefficients, and the face is reconstructed locally at the far end. When bandwidth dips, the compositor can momentarily lower the mesh subdivision level of the face or reduce normal-map detail while preserving lip-sync and eye motion so that social cues remain readable.

Because both clinician and patient are in VR, each sees the other in a shared virtual consultation room. Spatialized audio is rendered at the apparent mouth location of the reconstructed face so that audiovisual cues remain aligned. Gaze is conveyed by mapping the inward eye-tracking signals to the enrolled face's eye rig; when the clinician looks at a specific virtual object (e.g., a CTA vessel model), the patient sees the clinician's eyes and head orient appropriately, improving joint attention. The same enrollment and streaming workflow integrates cleanly with the holographic telepresence architecture previously described for clinical education and patient interactions, including secure intranet transport and room-stable spatial registration that were validated in Holo-Stroke deployments.

From an operational standpoint, the pre-conference enrollment need only be performed once per user or when appearance changes materially; it can be as short as 30-60 seconds and runs on the same multi-camera rig used for volumetric capture. The system stores a privacy-scoped profile tied to device credentials and encrypts both the stored template and the live side-channel. In clinics that already use holographic conferencing and volumetric imaging, the addition of this headset-aware facial restoration yields a co-present experience: even in fully virtual rooms, clinician and patient perceive each other's actual faces—eyes, brows, and mouth—rather than an occluding visor, improving rapport and comprehension while retaining the low-latency, spatially anchored communication flow of the base system.

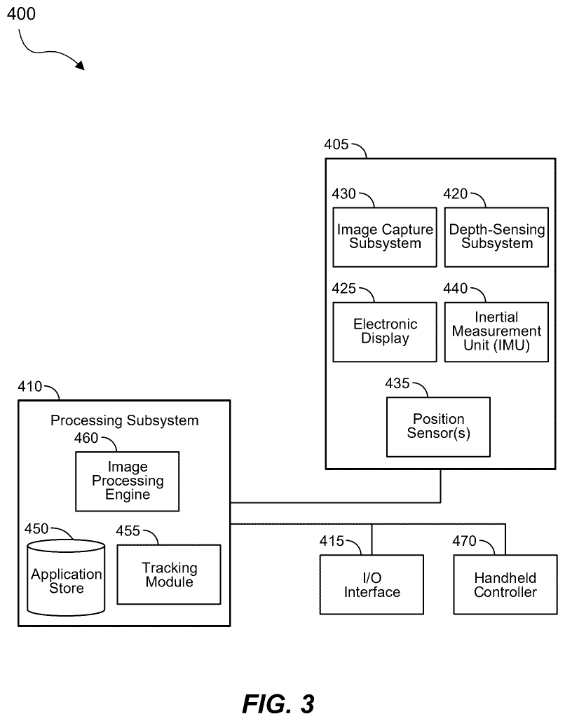

FIG. 3 illustrates an exemplary hardware and software architecture 400 of a spatial display device or mixed-reality headset configured to perform the holographic rendering operations of the preceding method. The architecture 400 may be embodied in a self-contained head-mounted display, a handheld augmented-reality viewer, or a distributed configuration in which some processing components reside in a remote compute pack or cloud-based rendering node. The architecture is organized around a processing subsystem 410 that provides the computational foundation for real-time volumetric decoding, scene reconstruction, and interactive rendering. The processing subsystem 410 may include one or more multi-core central processing units (CPUs) operating in conjunction with graphics-processing units (GPUs), digital-signal processors (DSPs), and dedicated neural-network accelerators integrated within a system-on-chip device. These heterogeneous processors execute firmware and application code responsible for decoding the incoming volumetric data streams, reconstructing the three-dimensional geometry, compositing it with environmental imagery, and displaying the result to the user with minimal latency.

The processing subsystem 410 operates in concert with an image-processing engine 460 that implements the decoding pipeline for compressed volumetric data, such as video-based point-cloud streams. The engine 460 receives encoded geometry and texture atlases transmitted over the network and uses hardware HEVC or AV1 decoders to recover the two-dimensional representations. A reprojection module within the GPU transforms the decoded patches back into three-dimensional space, generating a dense point cloud or polygonal mesh. Post-processing operations such as lighting correction, texture blending, temporal smoothing, and anti-aliasing may be applied to maintain visual coherence. In certain embodiments, neural radiance-field decoders reconstruct continuous volumetric scenes directly from compact latent representations, producing photorealistic results while significantly reducing network bandwidth requirements.

The spatial display device further includes a depth-sensing subsystem 420 and an image-capture subsystem 430 that together acquire information about the physical environment surrounding the user. The depth-sensing subsystem 420 may employ structured-light projectors, infrared emitters, or time-of-flight lidar sensors to measure the distance from the headset to nearby surfaces, thereby producing dense depth maps. The image-capture subsystem 430 may comprise a pair of forward-facing RGB cameras, side-facing cameras, or fisheye sensors that provide wide-field visual imagery for environmental mapping and video pass-through. The data from subsystems 420 and 430 support simultaneous localization and mapping (SLAM), hand-tracking, and spatial occlusion of holographic objects behind real-world obstacles. By integrating these sensors, the headset maintains an accurate, continuously updated model of the room geometry, which allows the rendered hologram to coexist naturally within the user's surroundings.

An electronic display 425 presents the composited images to the user's eyes. Depending on the embodiment, the display may be an optical see-through configuration employing holographic waveguides or reflective combiners that inject light from micro-projectors into the user's field of view, or an opaque micro-OLED panel used for full-immersion virtual-reality visualization. The display operates at refresh rates typically between 90 and 120 hertz and is synchronized to the rendering pipeline to keep motion-to-photon latency below about 20 milliseconds, ensuring that visual updates remain perceptually instantaneous during head movements.

An inertial-measurement unit 440 provides high-frequency measurements of angular velocity and linear acceleration. These signals are fused with positional information from one or more position sensors, which may include infrared tracking cameras or visual-odometry modules, within a tracking module 455. The tracking module 455 executes sensor-fusion algorithms, such as extended Kalman filters or SLAM filters, to compute the headset's six-degree-of-freedom pose relative to the global coordinate frame. The head-pose estimate updates at rates exceeding 500 hertz, maintaining sub-millimeter positional stability of the holographic imagery even during rapid movement. The tracking module 455 also supplies predictive pose data to the rendering pipeline, allowing the system to extrapolate the next frame's viewpoint and thereby compensate for motion latency.

The I/O interface 415 provides connectivity between the user and the holographic system. The interface may support one or more handheld controllers 470, glove-based sensors, or gesture-recognition modules. Each controller 470 may include an inertial sensor, capacitive touch surface, and haptic actuator that provides tactile feedback corresponding to virtual interactions. The controllers communicate wirelessly with the headset, transmitting position and orientation data with sub-centimeter accuracy. In certain configurations, explicit controllers are omitted, and the headset relies entirely on vision-based hand-tracking algorithms that recognize skeletal hand poses from the depth images provided by subsystem 420. The I/O interface 415 may further integrate microphones for natural-language commands, enabling voice-based control of holographic objects and user-interface elements.

The application store 450 hosts executable software components and domain-specific applications for telepresence, design collaboration, surgical visualization, or immersive training. Each application communicates with the lower-level tracking and rendering engines through standardized application-programming interfaces (APIs), enabling consistent access to the headset's spatial-mapping and rendering functions while maintaining system security and isolation. The application store 450 may also provide update mechanisms for firmware and runtime libraries, ensuring that the device maintains compatibility with evolving volumetric-streaming standards.

All of these components are generally coupled through high-speed electronic buses that connect the processing subsystem 410 with local storage, communication interfaces, and peripheral modules. The device may incorporate non-volatile memory for storing program code and cached volumetric data, as well as wireless transceivers for Wi-Fi, 5G, and Bluetooth connectivity. Optional wired connections such as USB-C or optical fiber may be used for tethered operation or high-bandwidth data exchange.

Alternative embodiments of the architecture 400 distribute processing responsibilities among multiple cooperating devices. In one example, a lightweight headset streams head-pose and sensor data to a nearby compute pack worn on the user's belt or mounted on a workstation. The compute pack performs the computationally intensive volumetric decoding and rendering and transmits final stereoscopic frames back to the headset for display. In another configuration, the volumetric decoding and rendering are executed on a remote cloud server equipped with a high-performance GPU cluster, while the headset functions primarily as a display and sensor platform. This modular arrangement allows the system to balance performance, power consumption, and cost according to the requirements of the particular application.

The integration of the processing subsystem 410, the image-processing engine 460, the depth-sensing and image-capture subsystems 420 and 430, the display 425, the inertial-measurement unit 440, the tracking module 455, the I/O interface 415, the controllers 470, and the application store 450 collectively enables low-latency, high-fidelity rendering of volumetric holograms that remain spatially stable and responsive to user input. Through continuous tracking, predictive rendering, and real-time sensor fusion, the architecture 400 provides the perceptual illusion that remote participants and digital objects coexist physically within the same environment as the user, thereby realizing the effect of true holographic telepresence.

Alternative embodiments of the architecture 400 may separate functionality across multiple cooperating devices. For instance, a lightweight headset may stream head-pose data to a nearby compute pack that performs volumetric decoding and rendering, transmitting only the final stereoscopic frames back to the headset. In another embodiment, the rendering engine may execute on a cloud server using a ray-tracing GPU cluster, while the local device handles only display and tracking. The modular design of the architecture 400 therefore allows adaptation to diverse performance, power, and cost targets.

In all embodiments, the integration of the subsystems shown in FIG. 3 enables low-latency, high-fidelity rendering of volumetric holograms that remain spatially stable and responsive to user interaction, providing the perceptual impression that the remote participant or object is physically co-present in the user's environment.

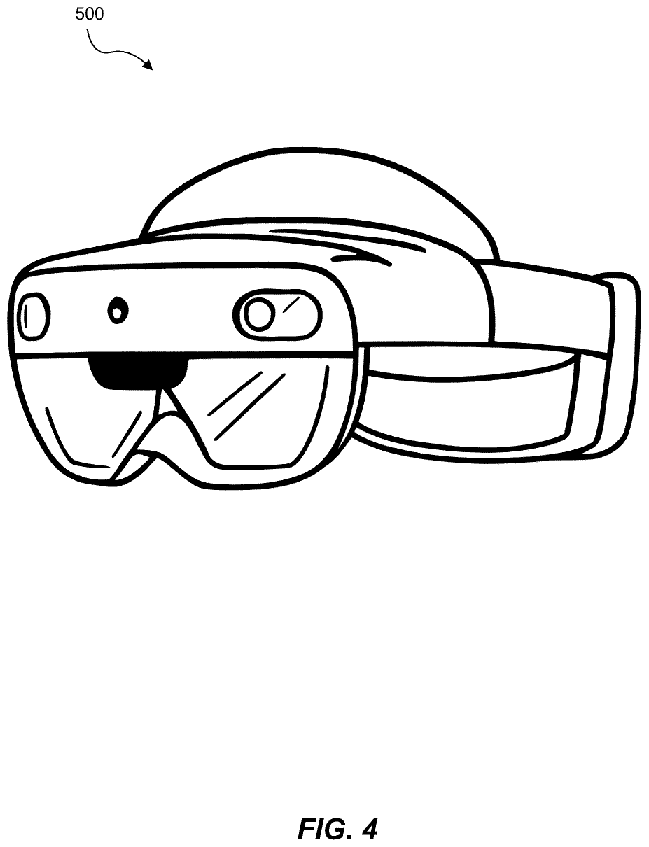

FIG. 4 illustrates an exemplary head-mounted spatial display device 500 that may be employed as the spatial display device of FIGS. 1-3. The headset 500 enables a user to perceive holographic imagery superimposed upon the real physical environment, thereby facilitating natural three-dimensional interaction with remote participants or virtual objects. The illustrated configuration is merely one representative embodiment; many variants may be realized according to desired form factor, optical performance, or computational distribution.

The headset 500 comprises a support frame shaped to rest upon the user's head, an optical visor assembly, and various embedded electronics. The visor assembly houses one or more optical combiners that guide light from micro-display projectors toward the user's eyes while remaining at least partially transparent so that real-world light passes through. Each combiner may include a multilayer waveguide or holographic optical element designed to in-couple and out-couple projected light using diffraction gratings patterned within a transparent substrate. In another embodiment, the visor employs a “birdbath” optical configuration, wherein a partially reflective curved mirror overlays the projected virtual image onto the user's direct view of the physical environment.

Paired micro-displays may be mounted within the visor and generate the left-and right-eye images that compose the stereoscopic holographic view. These displays may employ micro-OLED panels with resolutions exceeding 2048×2048 pixels per eye, or laser-scanned micro-electromechanical (MEMS) projectors that deliver wide color gamut and high brightness suitable for daylight operation. The display driver circuitry is synchronized to the headset's motion sensors so that visual updates remain phase-locked to head motion, maintaining motion-to-photon latencies below approximately 20 milliseconds.

An array of environmental cameras and sensors is integrated around the visor perimeter. Forward-facing cameras capture the scene for video pass-through, environmental mapping, and depth estimation. In one embodiment, a pair of stereo cameras operates at 90 frames per second to generate dense depth maps that inform occlusion handling—allowing virtual objects to correctly appear behind real-world surfaces. Additional sensors, such as near-infrared (IR) illuminators, structured-light projectors, or time-of-flight (ToF) modules, may augment the system for robust tracking under low-light conditions.

The headset 500 also includes a sensor suite for head and eye tracking. One or more inertial-measurement units (IMUs) detect angular rate and linear acceleration; these data are fused with visual odometry from the external cameras to yield a six-degree-of-freedom head pose. Inside the visor, miniature eye-tracking cameras observe the corneal reflections of infrared light sources to determine the user's gaze vector. Eye-tracking data may be used for foveated rendering—wherein the region of gaze is rendered at full resolution while peripheral regions are rendered at lower resolution—or as an interaction modality for selecting virtual objects simply by looking at them.

Spatialized audio transducers are mounted near the user's ears, often within open-ear speaker modules or bone-conduction pads 556, that produce directional audio aligned with holographic sources. A microphone array provides duplex communication and voice-command input while enabling acoustic echo cancellation. In medical embodiments, the array may further capture ambient audio for documentation or teleconsultation recording, subject to encryption and compliance protocols.

The headset's on-board processing electronics may include a system-on-chip for local rendering and sensor fusion, as described in FIG. 3, or may function as a lightweight terminal tethered to an external compute pack via a high-bandwidth wireless link. The compute pack may perform heavy decoding of volumetric data streams, ray tracing, or neural rendering before transmitting frame-buffered images to the headset. A high-capacity rechargeable battery housed within the rear strap provides power, and a thermal-management structure of heat pipes and graphite sheets maintains safe surface temperatures during continuous use.

Calibration of the headset 500 may occur at startup through a structured sequence in which the device projects fiducial patterns and measures environmental responses, thereby aligning its internal coordinate frame with the physical space. In medical use, the calibration may establish a “room anchor” corresponding to a patient bed or instrument table so that the hologram of a remote provider or anatomical dataset remains registered at a consistent real-world location.

Alternative embodiments of the headset 500 include: a compact see-through eyeglass design using diffraction-based waveguides; a projection-based tabletop unit that renders holograms above a surface for group viewing; and a fixed holographic display coupled to external tracking cameras that allows multiple viewers to share a common spatial experience without head-worn devices. Each embodiment may utilize the same volumetric rendering architecture and coordinate registration techniques described herein.

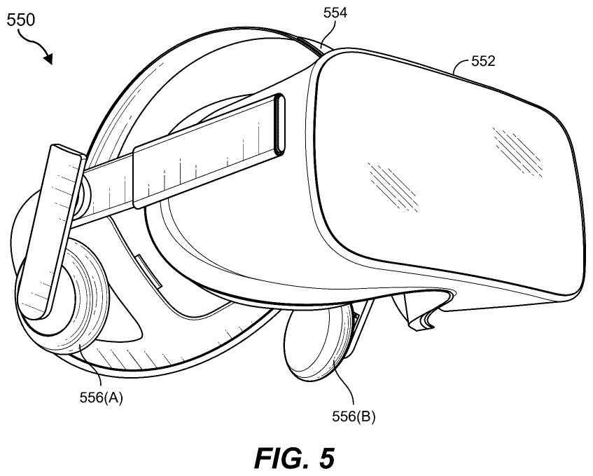

FIG. 5 depicts an alternative visualization device in the form of a virtual-reality headset 550, which may substitute for or operate in combination with the mixed-reality headset 500. The virtual-reality headset 550 provides a fully immersive environment in which the user's visual field is replaced by stereoscopic displays rendering a synthetic scene that can include holographic representations of remote participants, three-dimensional models, or simulated environments.

The headset 550 includes a front housing 552 that encloses left-and right-eye display modules. These modules may comprise high-refresh-rate LCD or micro-OLED panels positioned before each eye, coupled with Fresnel or pancake-type lenses that collimate the emitted light toward the eyes while minimizing chromatic aberration and distortion. The optics may include mechanical interpupillary-distance (IPD) adjustment mechanisms to accommodate different users. The front housing is supported by a headband 554 that distributes the weight evenly around the head and may incorporate foam pads or elastic straps for comfort during extended use.

On opposing sides of the headband are ear-cup assemblies 556(A) and 556(B). Each ear-cup assembly may contain spatialized speakers, haptic actuators, or vibration transducers that provide audio and tactile feedback correlated with virtual events. For instance, a user might feel a pulse when virtually touching an object or hear directional audio corresponding to the holographic position of a remote speaker. In some embodiments, the ear-cup assemblies house additional batteries, wireless transceivers, or cooling fans to manage heat generated by internal processors.

The headset 550 may implement inside-out tracking through a constellation of wide-angle cameras mounted on the housing 552. These cameras observe the surrounding room and use visual-inertial odometry algorithms to compute the headset's 6-DoF pose. The IMU within the headset provides high-frequency inertial data that are fused with optical tracking to minimize drift. In alternative embodiments, outside-in tracking may be used, wherein external beacons or base stations emit infrared patterns detected by sensors on the headset, achieving sub-millimeter precision suitable for high-fidelity simulation or surgical telepresence.

Unlike the optical-see-through configuration of FIG. 4, the headset 550 employs opaque displays that fully replace the real-world view with rendered imagery. However, pass-through mixed-reality modes may be enabled by using the front-mounted cameras to capture real-world video and re-display it on the internal panels in real time, allowing a seamless transition between full immersion and augmented visualization. In telemedicine applications, this capability enables a clinician to view patient data overlays or remote colleagues within a reconstructed room environment without removing the headset.

The virtual-reality system may execute a dedicated rendering engine that constructs a virtual meeting room or simulation space. Within this environment, decoded volumetric data streams received from remote capture systems (as produced by the method of FIG. 2) are instantiated as live, animated holographic avatars positioned at realistic scale and orientation. Users can walk around the holographic figure, change viewing angles, and interact through natural gestures. Audio is synchronized with the volumetric representation, and lip-synchronization may be preserved by embedding time-coded metadata within the transmitted stream.

In one medical embodiment corresponding to the Holo-Stroke and related systems, the VR headset 550 allows a neurologist at a remote site to appear as a life-sized hologram beside a patient or to manipulate three-dimensional radiologic imagery floating in space. The same framework can support surgical planning, anatomy instruction, or emergency teleconsultation. A clinician wearing headset 550 may perceive volumetric imaging data (such as CT or MRI scans) rendered as semi-transparent models that can be rotated, sliced, or annotated in real time. The patient or local provider, wearing the mixed-reality headset 500, perceives the same shared holographic content from their own perspective, establishing a bidirectional immersive communication channel.

Alternative embodiments of headset 550 may include modular optics for prescription-lens integration, detachable face gaskets for hygiene in medical use, and eye-safe laser-based displays offering variable focal planes to reduce vergence-accommodation conflict. Future variants may implement lightweight AR-VR hybrid glasses that dynamically switch between transparent and opaque states through liquid-crystal shutters or electrochromic films, enabling both mixed-reality and full-immersion operation in a single device.

In all configurations, the headset 550 cooperates with the system architecture previously described to deliver volumetric content with high spatial fidelity, low latency, and rich interactivity, producing the perceptual illusion that remote participants and digital objects coexist within the same physical or virtual environment as the user.

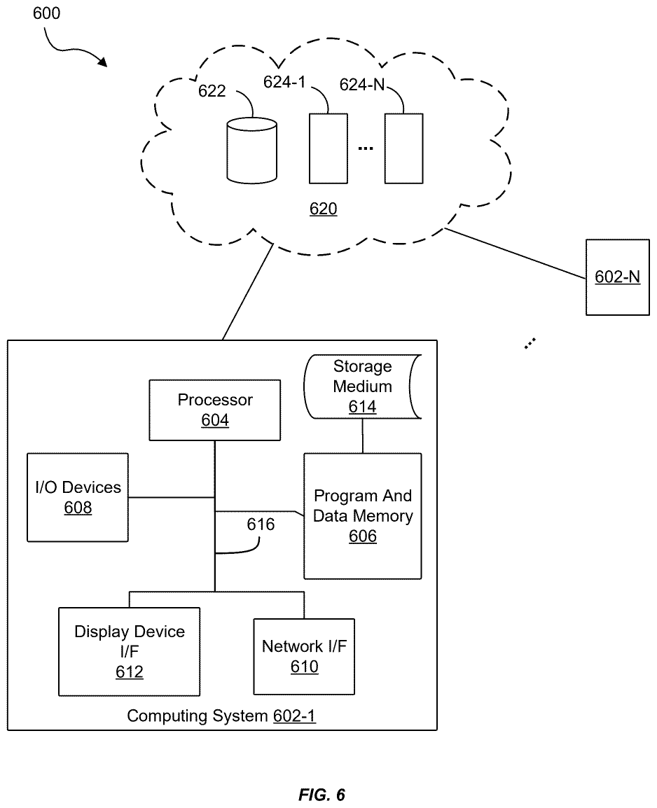

FIG. 6 illustrates an exemplary computing environment 600 operable to perform one or more operations associated with the systems and methods disclosed herein. The computing environment 600 may include one or more computing systems 602-1 through 602-N, which may be implemented as local devices, edge processors, or virtualized instances within a cloud computing network 620. Each computing system 602 may execute program instructions tangibly embodied on a computer-readable storage medium 614 to perform all or portions of the processes described with respect to the figures above.

Each computing system 602 may comprise at least one processor 604, program and data memory 606, one or more input/output (I/O) devices 608, a display device interface 612, a network interface 610, and a computer-readable storage medium 614, all coupled by a system bus 616. The processor 604 may represent any suitable processing circuitry, including a central processing unit (CPU), graphics processing unit (GPU), digital signal processor (DSP), field-programmable gate array (FPGA), application-specific integrated circuit (ASIC), or combinations thereof. In some embodiments, multiple heterogeneous processors may cooperate to execute parallelized reconstruction, compression, and rendering tasks for volumetric data.

The program and data memory 606 may store executable instructions and runtime data used by the processor 604. Such memory may include local cache, random-access memory (RAM), and bulk storage devices (e.g., solid-state drives or magnetic disks). The processor 604 may access portions of the memory 606 for temporary buffering of depth frames, volumetric meshes, and encoded data streams generated during real-time telepresence operation.

The I/O devices 608 may include peripherals such as keyboards, pointing devices, microphones, displays, or haptic interfaces, and may also encompass sensor inputs received from external capture hardware. The display interface 612 may drive integrated or remote display devices used to present holographic content or graphical user interfaces. The network interface 610 provides wired or wireless connectivity—such as Ethernet, Wi-Fi, cellular, or optical links-to communicate with other computing systems 602 or with the cloud computing network 620.

The computer-readable storage medium 614 may comprise any non-transitory medium capable of storing program code and data, including semiconductor memory, optical media, or magnetic storage. Examples include ROM, RAM, flash memory, CD-ROM, DVD, and Blu-ray Disc. Instructions stored on the storage medium 614, when executed by the processor 604, may cause the computing system 602 to carry out one or more of the operations described herein—such as depth-data fusion, volumetric reconstruction, encoding, transmission, decoding, rendering, or spatial registration.

In some embodiments, all or portions of these operations may be implemented within the cloud computing network 620, which may include one or more data storage modules 622 and distributed servers 624-1 through 624-N. The cloud network 620 may provide virtualized computing, storage, and networking infrastructure for large-scale volumetric data processing. Data from local computing systems 602 may be uploaded to the cloud network 620 for reconstruction, analysis, or long-term archiving, and results may be returned to client systems for rendering or visualization. The network 620 may support on-demand scaling, resource pooling, and measured service typical of modern cloud architectures.

Any combination of the computing systems 602 and the cloud servers 624 may cooperate to execute different stages of the disclosed methods. For instance, a local computing system 602-1 may perform initial acquisition and encoding of depth data, while the cloud network 620 reconstructs and optimizes volumetric representations before transmission to a remote computing system 602-N for rendering. In this manner, FIG. 6 represents a flexible computing framework in which hardware and software resources, whether local or distributed, operate collectively to perform the volumetric telepresence functions disclosed herein.

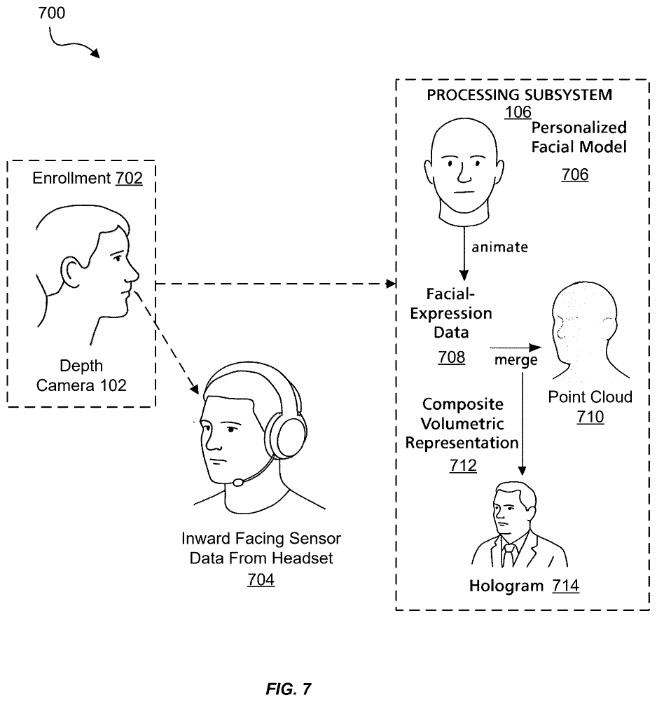

FIG. 7 illustrates an exemplary embodiment of a headset-aware volumetric telepresence system 700 configured to reconstruct and animate facial features of a participant even while the participant's face is partially occluded by a head-mounted display. The system 700 extends the processing subsystem 106 described in FIG. 1 to integrate inward-facing facial-capture data with externally acquired volumetric imagery in order to produce a composite, expressive holographic representation of the participant.

During a pre-conference enrollment phase 702, one or more depth cameras 102 capture multi-view depth and color imagery of the participant's uncovered face at high spatial and photometric resolution. Each camera may acquire depth maps at sub-millimeter accuracy and synchronized color images at resolutions of at least 1920×1080 pixels, ensuring sufficient detail for individual feature reconstruction. The captured data are processed by the processing subsystem 106 to generate a personalized facial model 706, which may include a parametric or topology-consistent face mesh incorporating vertex geometry, texture, normal, and albedo maps specific to the participant. In some embodiments, the model is trained using principal-component or blendshape bases that encode typical facial deformation modes. The resulting personalized facial model is stored locally and used thereafter as a reference template for real-time animation.

During a live telepresence session, the participant wears a headset equipped with one or more inward-facing sensors 704, which may include miniature near-infrared cameras positioned to image the eyes, nose, and mouth regions, an array of inertial sensors to capture micro-head motion, and directional microphones mounted near the mouth or chin to collect audio input. These sensors acquire continuous facial-expression data 708 representing partial imagery of the participant's face as it appears inside the headset, including eye gaze, eyelid closure, mouth shape, and jaw motion. The processing subsystem 106 receives these sensor streams and computes a set of expression parameters—such as blendshape weights, viseme indices, or muscle-based deformation vectors—that describe the participant's instantaneous facial configuration.

The processing subsystem 106 then applies the computed parameters to the personalized facial model 706 to animate the model in real time. The animated model reflects the participant's speech articulation and emotional expressions even though the headset obscures portions of the face. To complete the animation of regions hidden by the headset—such as the forehead, eyebrows, or upper cheeks—the system may employ a neural-network-based predictor trained on the participant's enrollment imagery and historical motion data. This learned model infers the motion of unobserved facial regions from partial visual cues, inertial readings, and contextual audio information, thereby reconstructing a full-face animation that preserves natural movement and synchrony with the participant's speech.

Simultaneously, one or more external depth-sensing cameras 102-1 through 102-N positioned around the capture zone acquire three-dimensional point-cloud data of the participant's body and head. The processing subsystem 106 reconstructs a volumetric representation of the participant as a point cloud 710. The animated facial model is spatially aligned and merged with this volumetric representation using a fusion algorithm that ensures geometric and photometric continuity. In one embodiment, the system 100 may perform Poisson-domain blending along the seam between the reconstructed facial mesh and the live-captured head geometry. In other embodiments, depth-aware feathering or weighted-vertex interpolation may be used to smooth the transition between the two datasets. A photometric equalization process may adjust color and illumination of the facial model to match that of the surrounding geometry, thereby minimizing visible seams and lighting discontinuities.

The fused dataset forms a composite volumetric representation 712 that combines the live-captured body with the dynamically animated, color-balanced facial model. The processing subsystem 106 encodes this composite representation into a transmission-ready bitstream, such as a video-based point-cloud compression stream augmented with animation metadata. The encoded data are transmitted across the network 110 to a remote spatial display device, which decodes and renders the composite representation as a life-sized hologram 714. The hologram includes natural facial animation, synchronized lip motion, and gaze direction consistent with the participant's expressions and speech, thus restoring the visual cues necessary for lifelike conversational telepresence. Through the integration of inward-facing facial capture, predictive animation, and volumetric fusion, the system 700 enables fully expressive holographic communication even when the participant's face is partially occluded by a headset.

The disclosed systems and methods provide several distinct advantages over conventional video-based telepresence or holographic communication platforms. By combining real-time volumetric reconstruction with spatially anchored rendering, the system preserves natural scale, depth, and perspective, enabling participants to interact as if co-located in the same room. The integration of headset-based inward-facing sensors and predictive facial animation restores full expressiveness even when the participant's face is partially obscured by a head-mounted display, improving the realism of eye contact and speech articulation. The dynamic calibration and fusion processes maintain geometric continuity and photometric consistency between captured and reconstructed imagery, ensuring a seamless holographic appearance. Bidirectional volumetric streaming further enables intuitive collaboration and shared manipulation of three-dimensional content. Collectively, these features deliver a level of immersion, presence, and communication fidelity not achievable with traditional two-dimensional video conferencing systems.

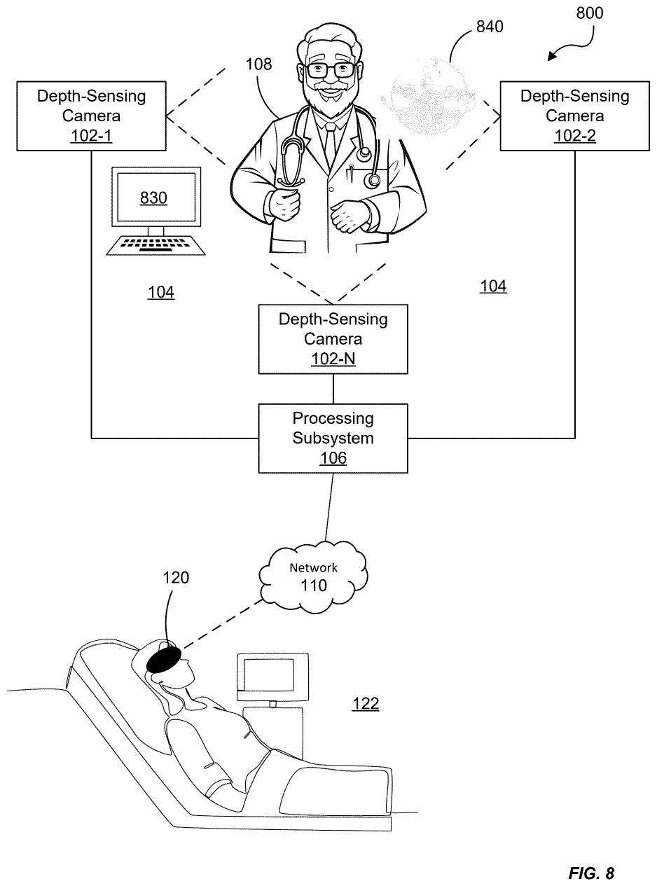

FIG. 8 illustrates an alternative embodiment of a system 800 for volumetric telepresence that expands upon the configuration of FIG. 1 to incorporate additional augmented-reality objects and clinical visualizations visible to a patient wearing augmented-reality (AR) goggles 120. As shown, a plurality of depth-sensing cameras 102-1 through 102-N are arranged around a capture zone in which a medical practitioner 108 is located. Each camera is coupled to a processing subsystem 106 via respective data links 104. The cameras 102-1 . . . 102-N operate cooperatively to acquire synchronized color and depth data of the practitioner 108 in real time. The processing subsystem 106 reconstructs a volumetric representation of the practitioner 108 and transmits that encoded data stream over a network 110 to the patient's AR headset 120, which is worn by a patient resting on a hospital bed 122. In this embodiment, however, the telepresence environment presented to the patient extends beyond the holographic image of the practitioner to include additional holographic and mixed-reality content derived from the practitioner's own workspace and display environment.

The medical practitioner 108 may operate a computer 830 positioned within the capture zone. The computer 830 may be a workstation, laptop, or clinical terminal executing medical-imaging or telepresence software and connected to the processing subsystem 106 either locally or through the network 110. Because the cameras 102-1 . . . 102-N capture the practitioner 108 and the surrounding environment volumetrically, the computer 830 and its visible display surfaces are also reconstructed as part of the three-dimensional scene. Consequently, the image of the practitioner's computer 830—including any images, user-interface elements, or holographic visualizations shown thereon-may be rendered within the patient's view through the AR goggles 120. In some implementations, the processing subsystem 106 identifies planar surfaces corresponding to the computer display and projects those regions as dynamic textures or live video streams, thereby reproducing the practitioner's screen content in real time within the patient's holographic field of view. This allows the patient to see what the practitioner is viewing or manipulating, such as medical imaging data, educational graphics, or procedural illustrations.

In this embodiment, the practitioner 108 may also be wearing an augmented-reality headset similar to that shown in FIG. 4 or FIG. 5. When worn, the practitioner's headset enables the practitioner 108 to perceive a CTA hologram 840 corresponding to volumetric medical imagery such as computed-tomography angiography data. The CTA hologram 840 may be generated and rendered by the same processing subsystem 106 or by a companion imaging system operating in communication with the telepresence network 110. The volumetric data for the CTA hologram 840 can be streamed from a PACS or imaging database, reconstructed as a three-dimensional vascular model, and spatially anchored within the practitioner's local coordinate frame so that the practitioner can manipulate and discuss the anatomical features during a consultation. Because the hologram 840 exists within the shared volumetric scene captured by the depth-sensing cameras 102-1 . . . 102-N, the holographic representation of the CTA image also becomes visible to the patient wearing the AR goggles 120. Accordingly, the patient perceives not only the holographic practitioner 108 but also the CTA hologram 840 as the practitioner sees and interacts with it.

To maintain natural eye contact and lifelike facial expression of the practitioner 108 while the practitioner is wearing AR goggles, the system 800 incorporates the headset-aware facial-reconstruction techniques described previously with respect to FIG. 7. The practitioner's headset includes inward-facing sensors that acquire facial-expression data even though portions of the face are occluded by the headset housing. During an enrollment phase, the processing subsystem 106 generates a personalized facial model of the practitioner 108 using multi-view depth and color imagery of the uncovered face. During operation, the facial-expression data acquired from the headset's inward-facing cameras are applied to animate the practitioner's personalized facial model in real time. The animated facial model is merged with the live volumetric reconstruction of the practitioner's body captured by the external depth-sensing cameras 102-1 . . . 102-N. Through Poisson-domain blending or depth-aware mesh fusion, the system 800 produces a continuous composite volumetric representation in which the practitioner's animated facial features appear natural and synchronized with speech. This composite representation, along with any associated holographic objects such as the computer 830 and the CTA hologram 840, is transmitted to the patient's headset 120 for display.

When viewed through the patient's AR goggles 120, the resulting scene appears as a spatially anchored, mixed-reality environment containing multiple holographic elements. The practitioner 108 appears life-sized and properly positioned relative to the patient's physical space, the practitioner's computer 830 may appear as a virtual display or workstation visible beside the practitioner, and the CTA hologram 840 may float in space between the practitioner and the patient. The patient may perceive the practitioner manipulating the holographic CTA model or pointing to regions of interest while explaining diagnostic findings. The AR headset 120 maintains continuous spatial registration so that each object remains fixed at its intended location regardless of the patient's movement or viewpoint. The network 110 supports bidirectional volumetric streaming so that the practitioner 108 can likewise see the patient in real time, enabling natural conversation and interaction.

This embodiment thus enables the simultaneous presentation of the practitioner's holographic image, medical imaging data such as the CTA hologram 840, and contextual environmental objects such as the practitioner's computer 830 within the patient's augmented-reality view. The integration of headset-aware facial animation ensures realistic expression and communication even while the practitioner is wearing AR goggles. Collectively, these features allow a patient to experience an immersive and informative holographic consultation in which both human and digital medical content are rendered together in three-dimensional space, greatly enhancing comprehension and the sense of shared presence within a telemedical encounter.

What is claimed is:

1. A system for volumetric telepresence, comprising:
a plurality of depth-sensing cameras positioned around a capture zone and configured to acquire synchronized depth and color data of a participant in real time;
a processing subsystem configured to reconstruct a volumetric representation of the participant from the synchronized depth and color data, to encode the volumetric representation as a data stream, and to transmit the encoded data stream over a network to a remote spatial display device;
the spatial display device being configured to:
decode the volumetric representation;
render the decoded volumetric representation of the participant as a hologram spatially anchored within a local physical environment of the spatial display device; and
maintain spatial registration between a coordinate system of the local physical environment and the capture zone such that the hologram appears at a corresponding position and orientation within the capture zone and the local physical environment,
wherein the system is further configured to update the spatial registration dynamically during motion of the participant, and to maintain real-time synchronization of the volumetric representation for conversational interaction.

2. The system of claim 1, wherein:
the spatial registration between the coordinate system of the local environment and the remote capture zone is performed using fiducial-marker detection, simultaneous localization and mapping (SLAM), or sensor-fusion techniques that combine inertial and optical tracking data.

3. The system of claim 1, wherein:
the processing subsystem is further configured to compress the volumetric representation using a point-cloud codec optimized for real-time transmission with latency below about 100 milliseconds.

4. The system of claim 1, wherein:
the spatial display device comprises a virtual reality head-mounted display configured to render the hologram of the participant with six-degree-of-freedom parallax corresponding to movement of a viewer.

5. The system of claim 1, wherein:
the spatial display device is further configured to detect hand gestures and eye-gaze direction of a viewer, and to interpret the gestures and the eye gaze as interaction commands for manipulating shared spatial content within the local physical environment.

6. The system of claim 1, wherein:
the system is further configured to maintain bidirectional volumetric streaming such that the volumetric representation of the participant is captured, transmitted, and rendered at the spatial display device in real time.

7. The system of claim 1, wherein:
the system is further configured to spatially co-locate digital objects within both the capture zone and the local physical environment to enable collaborative manipulation of shared three-dimensional content by the participant and a viewer.

8. The system of claim 1, wherein:
the system dynamically adjusts calibration parameters of the depth-sensing cameras and the spatial display device during operation to compensate for drift or environmental change while preserving geometric correspondence between the capture zone and the local physical environment.

9. The system of claim 1, wherein:
the processing subsystem is further configured to perform temporal smoothing or motion-prediction filtering of the synchronized depth and color data to reduce frame-to-frame jitter in the rendered hologram while maintaining real-time responsiveness.

10. The system of claim 1, wherein:
the spatial display device is further configured to adjust lighting, shading, or color balance of the rendered hologram based on ambient-light measurements of the local physical environment to improve visual integration of the hologram with real-world surroundings.

11. The system of claim 1, wherein:
the spatial display device is further configured to render, within a shared augmented-reality environment, a volumetric holographic representation of a remote medical practitioner and a volumetric medical image derived from computed-tomography angiography (CTA) data.

12. The system of claim 1, wherein:
the spatial display device is further configured to render, within a shared augmented-reality environment, a volumetric holographic representation of a remote medical practitioner with holographic objects representative of objects in the capture zone.

13. A method for volumetric telepresence, comprising:
acquiring, with a plurality of depth-sensing cameras positioned around a capture zone, synchronized depth and color data of a participant in real time;
reconstructing, by a processing subsystem, a volumetric representation of the participant from the synchronized depth and color data;
encoding and transmitting, by the processing subsystem, the volumetric representation as a data stream over a network to a remote spatial display device;
receiving, by the spatial display device, the transmitted volumetric representation;
decoding, by the spatial display device, the volumetric representation;
rendering, by the spatial display device, a hologram of the participant spatially anchored within a local physical environment of the spatial display device; and
maintaining spatial registration between a coordinate system of the local physical environment and the capture zone such that the hologram appears at a corresponding position and orientation within the capture zone and the local physical environment,
wherein the spatial registration is dynamically updated during motion of the participant, and the volumetric representation is maintained in real-time synchronization for conversational interaction.

14. The method of claim 13, wherein maintaining the spatial registration comprises:
calibrating the coordinate systems using fiducial-marker detection, simultaneous localization and mapping (SLAM), or sensor-fusion techniques combining inertial and optical tracking data.

15. The method of claim 11, further comprising:
compressing the volumetric representation using a point-cloud codec optimized for real-time transmission with latency below about 100 milliseconds.

16. The method of claim 13, further comprising:
rendering the hologram of the participant with six-degree-of-freedom parallax corresponding to movement of a viewer of the spatial display device.

17. The method of claim 13, further comprising:
detecting hand gestures and eye-gaze direction of the viewer and interpreting the gestures and the eye gaze as interaction commands for manipulating shared spatial content within the local physical environment.

18. The method of claim 13, further comprising:
maintaining bidirectional volumetric streaming such that a volumetric representation of each participant is captured, transmitted, and rendered at the corresponding remote spatial display device in real time.

19. The method of claim 13, further comprising:
spatially co-locating digital objects within both the capture zone and the local physical environment to enable collaborative manipulation of shared three-dimensional content by the participant and the viewer.

20. The method of claim 13, further comprising:
dynamically adjusting calibration parameters of the depth-sensing cameras and the spatial display device during operation to compensate for drift or environmental change while preserving geometric correspondence between the capture zone and the local physical environment.

21. The method of claim 13, further comprising:
applying temporal smoothing or motion-prediction filtering to the synchronized depth and color data to reduce frame-to-frame jitter in the rendered hologram while maintaining real-time responsiveness.

22. The method of claim 13, further comprising:
adjusting lighting, shading, or color balance of the rendered hologram based on ambient-light measurements of the local physical environment to improve visual integration of the hologram with real-world surroundings.

23. The method of claim 13, wherein:
the spatial display device is further configured to render, within a shared augmented-reality environment, a volumetric holographic representation of a remote medical practitioner and a volumetric medical image derived from computed-tomography angiography (CTA) data.

24. The method of claim 13, wherein:
the spatial display device is further configured to render, within a shared augmented-reality environment, a volumetric holographic representation of a remote medical practitioner with holographic objects representative of objects in the capture zone.

25. A system for headset-aware volumetric telepresence, comprising:
one or more depth-sensing cameras positioned around a capture zone and configured to acquire synchronized depth and color data of a participant in real time;
a processing subsystem configured to reconstruct a volumetric representation of the participant from the synchronized depth and color data; and
a headset worn by the participant and including one or more inward-facing sensors configured to capture facial-expression data of the participant while the participant's face is partially occluded by the headset;
the processing subsystem being further configured to:
generate, during a pre-conference enrollment phase, a personalized three-dimensional facial model of the participant based on multi-view depth and color imagery of the participant's uncovered face;
receive the facial-expression data from the headset;
animate the personalized facial model according to the facial-expression data;
merge the animated facial model with the reconstructed volumetric representation of the participant to produce a composite volumetric representation having a reconstructed face region; and
encode and transmit the composite volumetric representation to a remote spatial display device for real-time rendering as a holographic image including the participant's facial features.

26. The system of claim 25, wherein:
the personalized three-dimensional facial model comprises a parametric face mesh having user-specific texture, normal, and albedo maps generated from the pre-conference enrollment imagery.

27. The system of claim 25, wherein:
the headset further comprises inward-facing cameras, a chin-mounted camera, and one or more microphone arrays, and wherein the processing subsystem is further configured to determine expression parameters by combining visual, inertial, and audio-derived viseme data.

28. The system of claim 25, wherein:
the processing subsystem is further configured to transmit the reconstructed volumetric representation using a first video-based point-cloud compression (V-PCC) stream and transmits facial animation data as a second stream comprising blendshape coefficients and head-pose metadata.

29. The system of claim 28, wherein:
the remote spatial display device reconstructs the participant's facial model locally by applying the received blendshape coefficients to a stored facial template of the participant, thereby reducing transmission bandwidth while maintaining photorealistic facial animation.

30. The system of claim 25, wherein:
the processing subsystem is further configured to perform color and illumination matching between the reconstructed facial model and surrounding live-captured geometry using Poisson-domain blending or depth-aware feathering to minimize visual seams.

31. The system of claim 25, wherein:
the personalized facial model and facial-expression data are encrypted end-to-end, and wherein the processing subsystem is further configured to maintain the facial template locally such that only animation coefficients are transmitted across a network.

32. The system of claim 25, wherein:
the processing subsystem is further configured to apply a learned neural network to predict unobserved facial motion of regions occluded by the headset based on partial visual cues, inertial data, and prior enrollment imagery.

33. The system of claim 25, wherein:
the system further comprises the processing system is further configured to align spatialized audio output with a mouth position of the reconstructed facial model to provide directional speech consistent with the rendered holographic participant.
